(19) United States
(12) Patent Application Publication
(10) Pub. No.: US 2017/0021715 A1
(43) Pub. Date: Jan. 26, 2017

(54) PARALLEL POWER INPUT GEARBOX

(71) Applicant: HPEV, Inc., Tampa, FL (US)

(72) Inventors: Mark Hodowanec, Murrysville, PA (US); Timothy Hassett, Santa Rosa, CA (US)

(21) Appl. No.: 15/285,734

(22) Filed: Oct. 5, 2016

Related U.S. Application Data
(63) Continuation of application No. 14/446,584, filed on Jul. 30, 2014, now abandoned.
(60) Provisional application No. 61/863,606, filed on Aug. 8, 2013.

(51) Int. Cl. B60K 6/48; B60K 6/547; B62D 65/10; B60W 10/11; B60W 10/02; B60W 20/40; F16H 3/00; B60K 6/36

(52) U.S. Cl. CPC B60K 6/48; F16H 3/006; B60K 6/547; B60K 6/36; B60W 10/11; B60W 10/02; B60W 20/40; B62D 65/10; B60K 2006/4825; Y10S 903/902; B60Y 2200/92; B60Y 2300/42; B60Y 2300/70; B60Y 2304/076

(57) ABSTRACT

A retrofittable hybrid parallel power flow distribution system for a vehicle. In various embodiments, the system comprises an electric rotating machine and a parallel power input gearbox. The parallel power input gearbox is structured and operable to receive torque from the electric rotating machine and/or an internal combustion engine of the vehicle and selectively distribute the received torque, i.e., a power flow, in any proportion/ratio to one or more of the electric rotating machine, a rear axle differential of the vehicle, a transmission or transfer case and front axle of the vehicle, or an auxiliary device of the vehicle.

### CROSS-REFERENCE TO RELATED APPLICATIONS

This application is a Continuation of U.S. patent application Ser. No. 14/446,584, filed on Jul. 30, 2014, which claims the benefit of, as does the present application, U.S. Provisional Application No. 61/863,606, filed on Aug. 8, 2013, the disclosure of which are hereby incorporated by reference in their entirety.

### FIELD

The present teachings relate to a gearbox that enables a hybrid vehicle to operate in several hybrid modes as well as in various combinations to drive auxiliary devices.

### BACKGROUND

The statements in this section merely provide background information related to the present disclosure and may not constitute prior art.

Plug in Hybrid Electric Vehicles (PHEV) & Extended Range Electric Vehicles (EREV) have existed for a long time. Current development of PHEVs and EREVs is generally dependent on designing a ground up vehicle with the PHEV drivetrain as an integral part of the vehicle. More particularly, existing, non-PHEV and non-EREV vehicles are generally not convertible to hybrid, PHEV or EREV vehicles.

### SUMMARY

The present disclosure provides systems and methods for flexibly distributing the flow of power generated by an internal combustion engine and/or an electric rotating machine of a hybrid vehicle. In various embodiments, a retrofittable hybrid parallel power flow distribution system for a vehicle comprises an electric rotating machine and a parallel power input gearbox. The parallel power input gearbox is structured and operable to receive torque from the electric rotating machine and/or an internal combustion engine of the vehicle and selectively distribute the received torque, i.e., a power flow, in any proportion/ratio to one or more of the electric rotating machine, a rear axle differential of the vehicle, a transmission or transfer case of the vehicle, or an auxiliary device of the vehicle.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1A is a schematic of a known standard drivetrain for a 2-wheel drive vehicle.

FIG. 1B is a schematic of a known standard drivetrain for a 4-wheel drive vehicle.

FIG. 2 is a block diagram of a vehicle including a retrofittable hybrid parallel power flow distribution system for use in tandem with an internal combustion engine of the vehicle, in accordance with various embodiments of the present disclosure.

FIG. 3A is a schematic of the 2-wheel drive vehicle shown in FIG. 1A having the drivetrain modified to include the retrofittable hybrid parallel power flow distribution system shown in FIG. 2, in accordance with various embodiments of the present disclosure.

FIG. 3B is a schematic of the 2-wheel drive vehicle shown in FIG. 3A having the drivetrain modified to include the retrofittable hybrid parallel power flow distribution system shown in FIG. 2 including an auxiliary device, in accordance with various other embodiments of the present disclosure.

FIG. 4A is a schematic of the 4-wheel drive vehicle shown in FIG. 1B having the drivetrain modified to include the retrofittable hybrid parallel power flow distribution system shown in FIG. 2, in accordance with various embodiments of the present disclosure.

FIG. 4B a schematic of the 4-wheel drive vehicle shown in FIG. 4A having the drivetrain modified to include the retrofittable hybrid parallel power flow distribution system shown in FIG. 2 including and auxiliary device, in accordance with various other embodiments of the present disclosure.

FIG. 5 is a block diagram of the retrofittable hybrid parallel power flow distribution system shown in FIG. 2, wherein a parallel power input gearbox of the retrofittable hybrid parallel power flow distribution system is operated in a first power flow mode to distribute torque/power provided only from an internal combustion engine of the vehicle to a rear axle of a vehicle, in accordance with various embodiments of the present disclosure.

FIG. 6 is a block diagram of the retrofittable hybrid parallel power flow distribution system shown in FIG. 2, wherein the parallel power input gearbox is operated in a second power flow mode to distribute torque/power provided from only the internal combustion engine of the vehicle to an electric rotating machine of the retrofittable hybrid parallel power flow distribution system such that the electric rotating machine functions as a mobile generator, e.g., a standby electric generator, in accordance with various embodiments of the present disclosure.

FIG. 7 is a block diagram of the retrofittable hybrid parallel power flow distribution system shown in FIG. 2, wherein the parallel power input gearbox is operated in a third power flow mode to distribute torque/power provided from only the internal combustion engine of the vehicle to an auxiliary device of the retrofittable hybrid parallel power flow distribution system, in accordance with various embodiments of the present disclosure.

FIG. 8 is a block diagram of the retrofittable hybrid parallel power flow distribution system shown in FIG. 2, wherein the parallel power input gearbox is operated in a fourth power flow mode to distribute torque/power provided from only the internal combustion engine of the vehicle to the auxiliary device and to the electric rotating machine functioning as a mobile generator, e.g., a standby electric generator, in accordance with various embodiments of the present disclosure.

FIG. 9 is a block diagram of the retrofittable hybrid parallel power flow distribution system shown in FIG. 2, wherein the parallel power input gearbox is operated in a fifth power flow mode to distribute torque/power provided from both the internal combustion engine of the vehicle and the electric rotating machine to the rear axle of the vehicle, in accordance with various embodiments of the present disclosure.

FIG. 10 is a block diagram of the retrofittable hybrid parallel power flow distribution system shown in FIG. 2, wherein the parallel power input gearbox is operated in a sixth power flow mode to distribute torque/power provided from only the internal combustion engine of the vehicle to the auxiliary device and to the rear axle, in accordance with various embodiments of the present disclosure.

FIG. 11 is a block diagram of the retrofittable hybrid parallel power flow distribution system shown in FIG. 2, wherein the parallel power input gearbox is operated in a seventh power flow mode to distribute torque/power provided from both the internal combustion engine of the vehicle and the electric rotating machine to the auxiliary device and to the rear axle of the vehicle, in accordance with various embodiments of the present disclosure.

FIG. 12 is a block diagram of the retrofittable hybrid parallel power flow distribution system shown in FIG. 2, wherein the parallel power input gearbox is operated in a eighth power flow mode to distribute torque/power provided from only the electric rotating machine to the rear axle of the vehicle, in accordance with various embodiments of the present disclosure.

FIG. 13 is a block diagram of the retrofittable hybrid parallel power flow distribution system shown in FIG. 2, wherein the parallel power input gearbox is operated in a ninth power flow mode to distribute torque/power provided from only the electric rotating machine to the auxiliary device, in accordance with various embodiments of the present disclosure.

FIG. 14 is a block diagram of the retrofittable hybrid parallel power flow distribution system shown in FIG. 2, wherein the parallel power input gearbox is operated in a tenth power flow mode to distribute torque/power provided from only the electric rotating machine to the auxiliary device and to the rear axle of the vehicle, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

As used herein, the term ‘operatively connected’ and ‘operatively coupled’ will be understood to mean one or more components, systems, device or mechanisms of the present invention that are either directly connected/coupled or connected/coupled via a linking mechanism, e.g., linkage, one or more couplings, one or more gears, etc., such that the respective components, systems, devices or mechanisms are interoperable with each other. That is, the respective components, systems, devices or mechanisms interact with each other or work together such that operation/function of one can cause and/or affect the operation/function of the other.

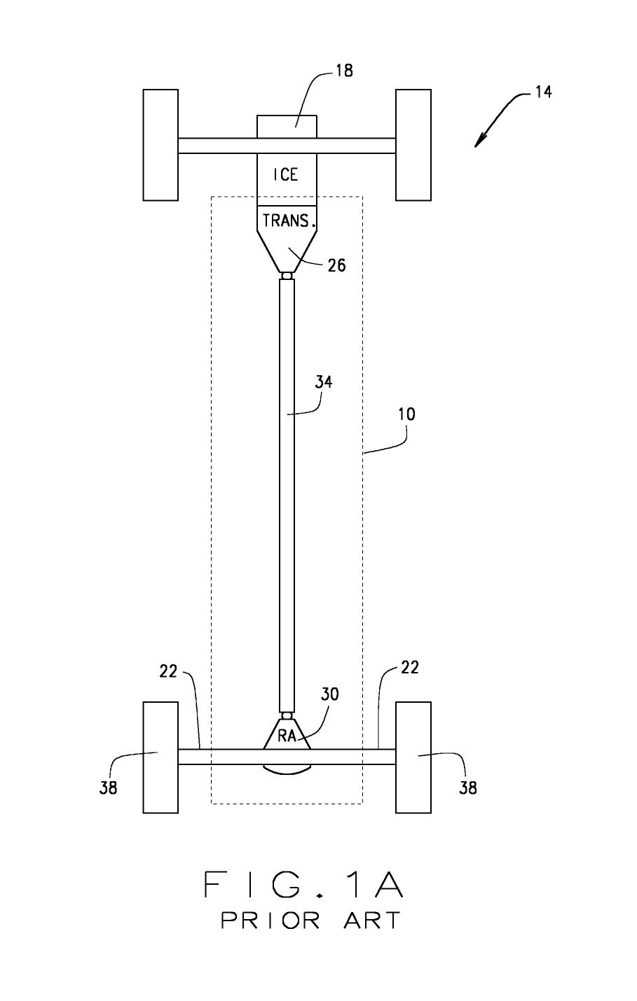

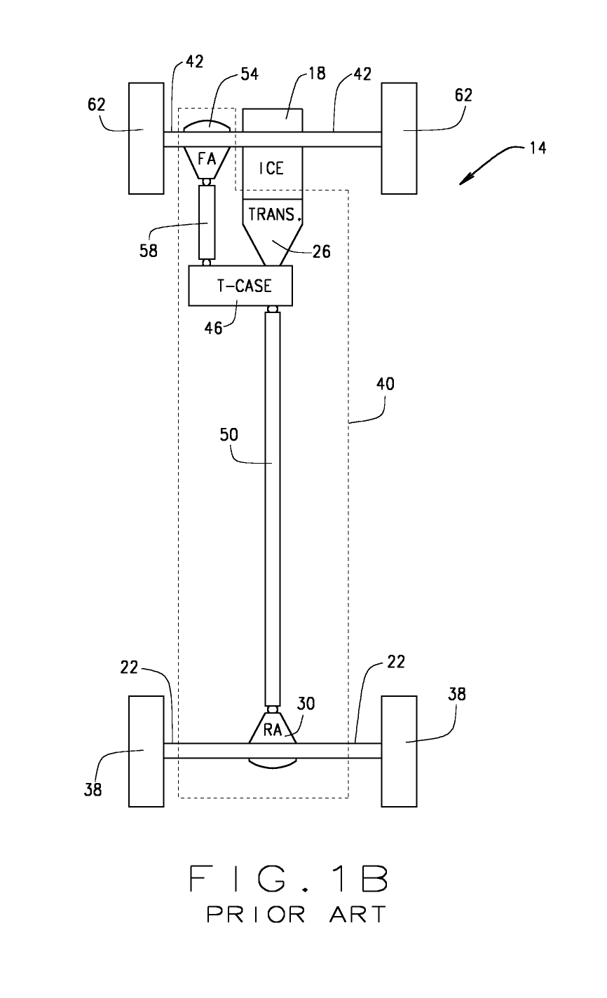

FIG. 1A illustrates a known standard 2-wheel drive drivetrain 10 for a fully assembled, fully functional and operational preexisting vehicle 14, such as an SUV, a pickup truck, a medium duty truck, a heavy duty truck, a bus, or any other vehicle. The drivetrain 10 is structured and operable to transfer power, i.e., torque, generated by an internal combustion engine 18 (ICE), e.g., a gasoline or diesel engine, of the vehicle 14 to a rear axle 22 of the vehicle 14 to provide motive power, or force, to the vehicle 14. Generally, the standard 2-wheel drive drivetrain 10 includes a transmission 26 coupled to the ICE 18, a rear axle differential 30 coupled to the rear axle 22, and a driveshaft 34 connected at opposing ends to the transmission 26 and the rear axle differential 30. The transmission 26 converts torque generated by the ICE 18 to a desired amount of torque and delivers the desired torque to the driveshaft 34. That is, the transmission 26 selectively steps-up and steps-down the torque generated by the ICE 18 such that the desired torque and a desired rotational speed is translated to the driveshaft 34. Subsequently, the driveshaft 34 delivers the desired amount of torque and rotational speed to the rear axle differential 30, whereby the rear axle differential 30 transfers the desired torque and rotational speed to the rear axle 22, which in turn transfers the desired torque and rotational speed to at least one of the rear wheels 38.

FIG. 1B illustrates a known standard 4-wheel drive drivetrain 40 for the fully assembled, fully functional and operational preexisting vehicle 14, such as an SUV, a pickup truck, a medium duty truck, a heavy duty truck, a military vehicle such as a Humvee/HMMWV, or any other suitable vehicle. The drivetrain 40 is structured and operable to transfer power, i.e., torque, generated by the internal combustion engine 18 (ICE) of the vehicle 14 to the rear axle 22 and/or a front axle 42 of the vehicle 14 to provide motive power, or force, to the vehicle 14. Generally, the standard 4-wheel drive drivetrain 38 includes the transmission 26 coupled to the ICE 18, a transfer case 46 coupled to the transmission 26, the rear axle differential 30 coupled to the rear axle 22, and a primary driveshaft 50 connected at opposing ends to the transfer case 46 and the rear axle differential 30. The standard 4-wheel drive drivetrain 38 additionally includes a front axle differential 54 coupled to the front axle 42 and a secondary driveshaft 58 connected at opposing ends to the transfer case 46 and the front axle differential 54. The transmission 26 converts torque generated by the ICE 18 to a desired amount of torque and delivers the desired torque to the transfer case 46. That is, the transmission 26 selectively steps-up and steps-down the torque generated by the ICE 18 such that the desired torque and a desired rotational speed is translated to the transfer case 46. Based on the configuration of the transfer case 46, controlled by a vehicle operator, the transfer case 46 delivers the desired torque and rotational speed to the primary driveshaft 50, the second driveshaft 58, or both the primary and secondary driveshafts 50 and 58. Subsequently, the respective primary and/or secondary driveshaft 50 and/or 58 deliver(s) the desired amount of torque and rotational speed to the respective rear and/or front axle differential(s) 30 and/or 54, whereby the respective rear and/or front axle differential(s) 30 and/or 54 transfer(s) the desired torque and rotational speed to the respective rear and/or front axle 22 and/or 42, which in turn transfers the desired torque and rotational speed to at least one of the rear wheels 38, at least one front wheel 62, or at least one rear wheel 38 and at least one front wheel 62.

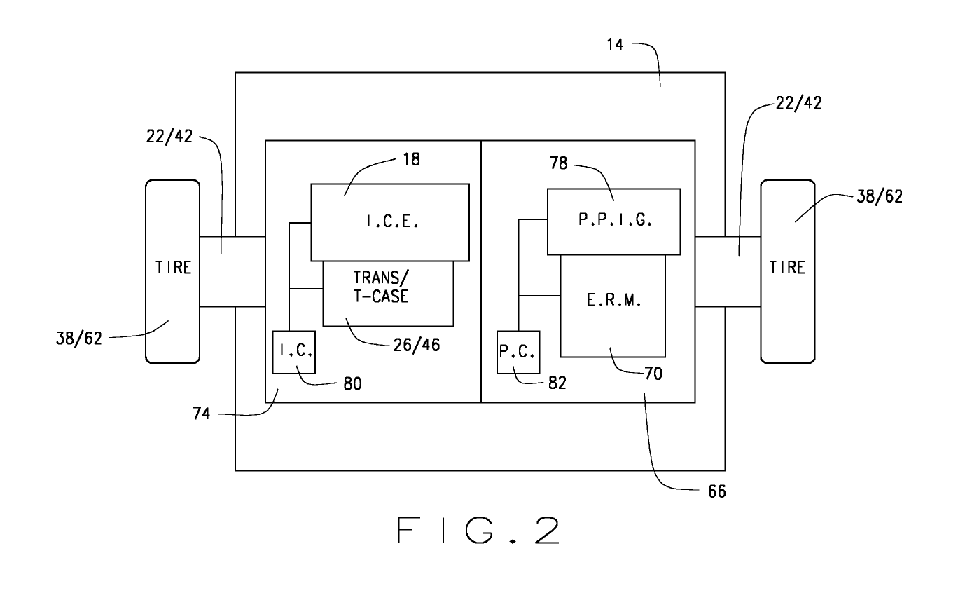

Referring now to FIG. 2, as described above, the present disclosure provides systems and methods for flexibly distributing the flow of power/torque generated by an internal combustion engine and/or an electric rotating machine of a hybrid vehicle. For example, in various embodiments, the present disclosure provides a retrofittable hybrid parallel power flow distribution system 66, simply referred to herein as the parallel power flow distribution system or (PPFDS) 66. The PPFDS 66 is retrofittable into an existing internal combustion engine vehicle 14, such as an SUV or pickup truck, a medium duty truck, a heavy duty truck, a bus, a military vehicle such as Humvee/HMMWV, or any other suitable vehicle, to convert the respective vehicle 14 to a hybrid vehicle capable of flexibly distributing power/torque generated by the ICE 18 and/or an electric rotating machine (ERM) 70, in any proportion or ratio, to any number of devices, systems, machines or mechanisms operatively connected to the PPFDS 66, as described below. Particularly, the driveshaft 34 (of a 2-wheel drive vehicle 14) or the primary driveshaft 50 (of a 4-wheel drive vehicle 14) is removed and replaced, or modified with the PPFDS 66 such that the PPFDS 66 is used and operated in tandem, or parallel, with an internal combustion engine drive system (ICEDS) 74 of the respective vehicle 14 to flexibly distribute the flow of power/torque generated by the ICE 18 and/or the electric rotating machine 70, as described further below.

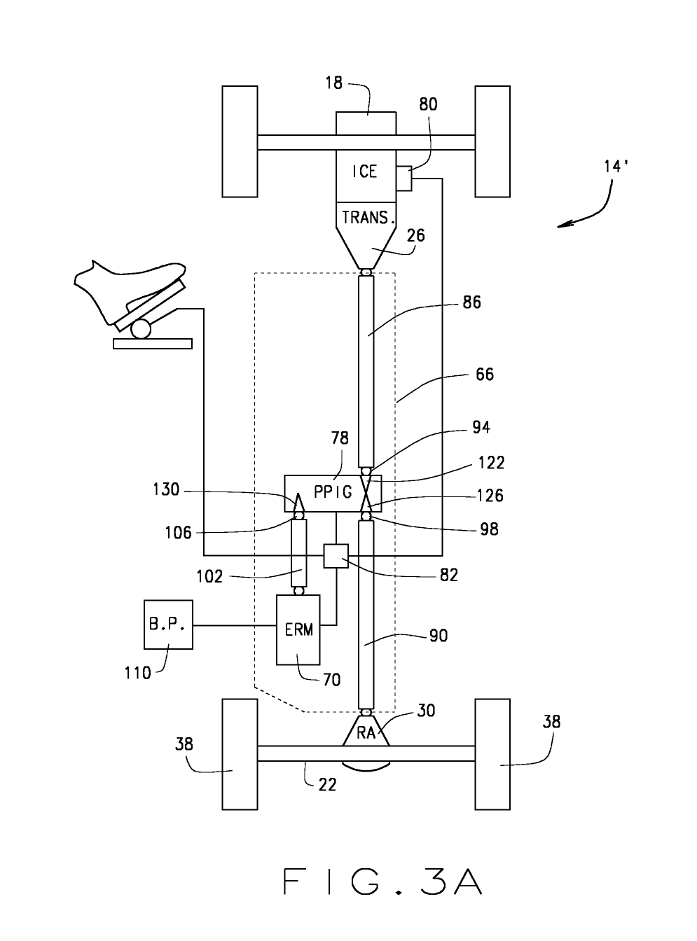

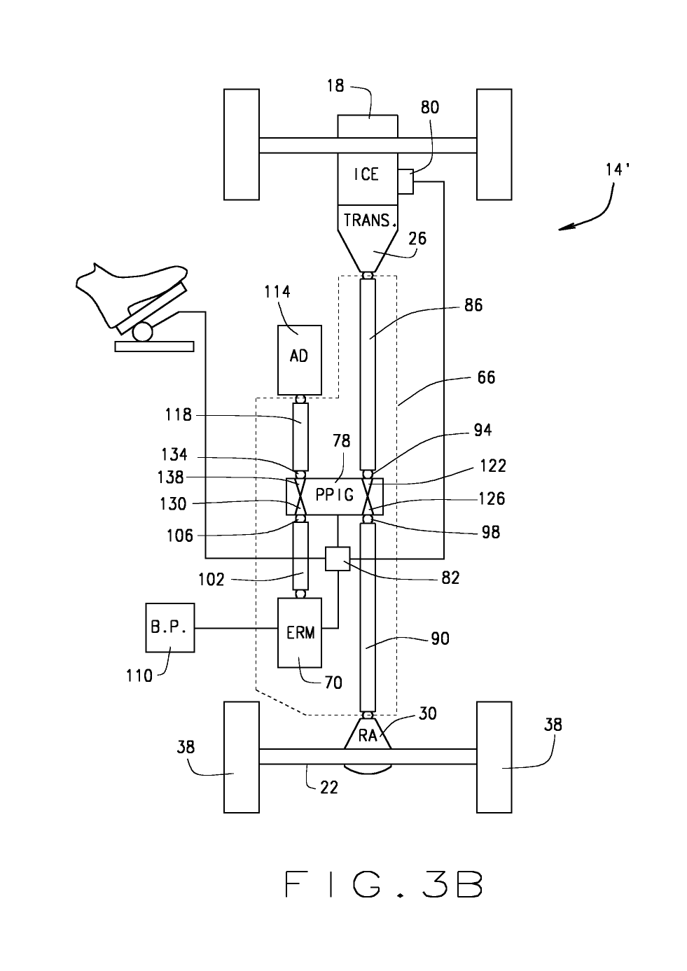

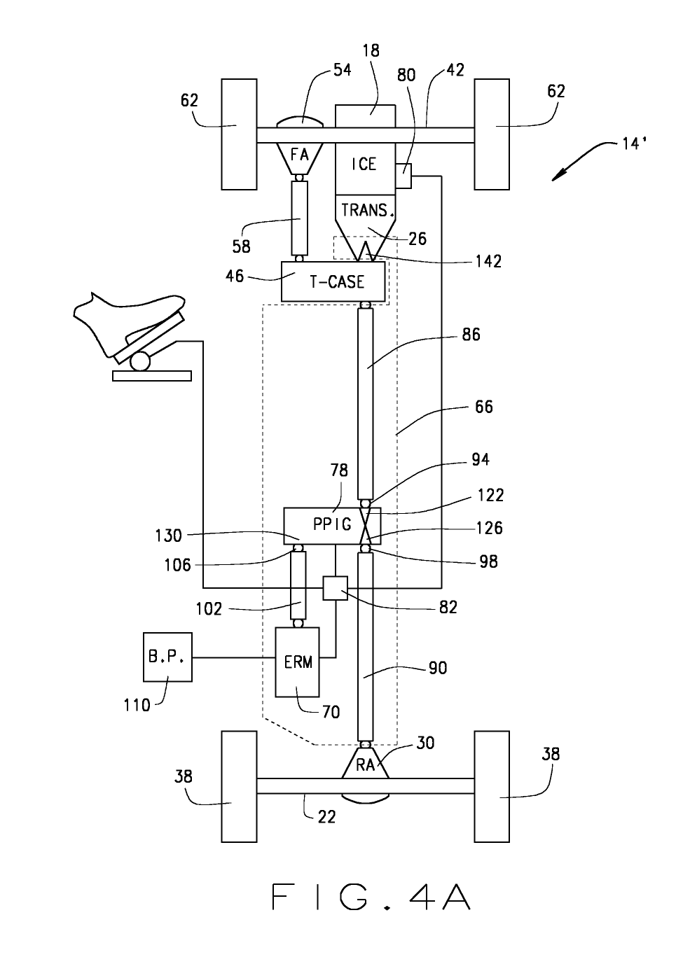

Generally, the ICEDS 74 includes the ICE 18 operatively connected to the transmission 26, as is well known in the art, and an ICEDS controller 80 (i.e., a microprocessor based controller) for controlling the operation of the ICEDS 74, as is well known in the art. The PPFDS 66 generally includes the electric rotating machine 70 operatively connected to a parallel power input gearbox 78 that is operatively connected to the transmission or transfer case 26 or 46 of the ICEDS 74 and to the rear axle differential 30 (shown in FIGS. 3A-4B) of the vehicle 14. The PPFDS 66 additionally includes a PPFDS gearbox controller 82 (i.e., a microprocessor based controller) that is structured and operable to control, among other things, the configuration, operation and functionality of the parallel power input gearbox 78. The parallel power input gearbox 78 will sometimes be referred to herein simply as the gearbox 78.

Referring now to FIGS. 3A through 4B, as described above, to install, or incorporate, the PPFDS 66 into the vehicle 14, the driveshaft 34 (of a 2-wheel drive vehicle 14) or the primary driveshaft 50 (of a 4-wheel drive vehicle 14) is removed and replaced with the PPFDS 66, thereby converting the vehicle 14 to a hybrid vehicle referred to herein as vehicle 14′. Particularly, the driveshaft 34 or 50 is removed and replaced with a first torque transfer shaft 86 of the PPFDS 66 and a second torque transfer shaft 90 of the PPFDS 66 that are operatively connected via the gearbox 78. More particularly, the first torque transfer shaft 86 is operatively connected at one end to a first power port 94 of the gearbox 78 and operatively connected at the opposing end to the transmission 26 or the transfer case 46 of the vehicle 14 (depending on whether the vehicle 14 is a 2-wheel drive or a 4-wheel drive vehicle). Similarly, the second torque transfer shaft 90 is operatively connected at one end to a second power port 98 of the gearbox 78 and operatively connected at the opposing end to the rear axle differential 30. As described further below, the first torque transfer shaft 86 is structured and operable to bidirectionally transfer torque between the gearbox 78 and the transmission 26 or the transfer case 46, and the second torque transfer shaft 90 is structured and operable to bidirectionally transfer torque between the gearbox 78 and the rear axle differential 30. Additionally, the PPFDS 66 includes a third torque transfer shaft 102 operatively connected at one end to a third power port 106 of the gearbox 78 and operatively connected at the opposing end to the ERM 70. The third torque transfer shaft 102 is structured and operable to bidirectionally transfer torque between the gearbox 78 and the ERM 70.

In various embodiments, the ERM 70 can be any electric rotating machine, e.g. an electric motor and/or generator, structured and operable to utilize electricity provided by a battery pack (i.e., a plurality of batteries) 110 to generate power/torque that can be delivered to the gearbox 78, via the third torque transfer shaft 102, and selectively distributed by the gearbox 78, as described further below. For example, in various embodiments, the ERM 70 can be a heat pipe cooled induction type traction motor that utilizes heat pipe cooling technology, such as those described in patent applications: Ser. No. 11/765,140, filed Jun. 19, 2007; Ser. No. 12/352,301 filed Jan. 12, 2009; and Ser. No. 12/418,162, filed Apr. 3, 2009, each of which are incorporated herein by reference in their entirety. In various other embodiments the ERM 70 can be a generator structured and operable to receive, via the third torque transfer shaft 102, power/torque from the gearbox 78, as described further below. In still other embodiments, the ERM 70 can be a motor and a generator structured and operable to, via the third torque transfer shaft 102, selectively generate power/torque delivered to the gearbox 78 and receive power/torque from the gearbox 78, as described further below.

Referring particularly to FIGS. 3A and 4A, as described above, the PPFDS 66 is used and operated in tandem, or parallel, with an internal combustion engine drive system (ICEDS) 74 of the respective vehicle 14 to convert the vehicle 14 to the hybrid vehicle 14′ and to flexibly distribute the flow of power/torque generated by the ICE 18 and/or the ERM 70. More specifically, the gearbox 78 comprises a plurality of gears that are operatively engageable with each other and with the first, second and third torque transfer shafts 86, 90 and 102, via the respective power ports 94, 98 and 106, to selectively distribute the flow of power/torque generated by the ICE 18 and/or the ERM 70 to any one or more of the first, second, and/or third torque transfer shafts 86, 90 and/or 102. It should be understood that, in various embodiments, the power/torque generated by the ERM 70 can be regenerative braking power/torque.

Even more specifically, the gearbox 78 comprises a first clutch mechanism 122 associated with the first power port 94, a second clutch mechanism 126 associated with the second power port 98 and a third clutch mechanism 130 associated with the third power port 106. Each of the first, second and third clutch mechanisms 122, 126 and 130 are structured and operable to: 1) be engaged to direct torque from the respective first, second and third torque transfer shaft 94, 98 and 102 into the gearbox 78; and 2) be engaged to direct torque from the gearbox 78 to the respective first, second and third torque transfer shaft 94, 98 and 102; and 3) be disengaged such that the respective the respective first, second and third torque transfer shaft 94, 98 and 102 is ‘neutralled’ and can neither direct torque into the gearbox 78 from the respective first, second, and third torque transfer shaft 94, 98 and 102, nor direct torque from the gearbox 78 to the respective first, second and third torque transfer shaft 94, 98 and 102.

Still even more specifically, as described further below, the gearbox 78 is configureable, via the gearbox controller 82 (envisioned to be disposed within the driver's area of the vehicle 14′), to selectively engage and/or disengage, independently or in any combination, each of the first, second and third clutch mechanisms 122, 126 and 130 to receive and/or deliver torque to and/or from any one or more of the first, second and third torque transfer shafts 94, 98 and 102. That is, gearbox 78 is configureable, via the gearbox controller 82, to flexibly distribute the flow of power/torque generated by the ICE 18 and/or the ERM 70 and/or the rear axle differential (e.g., regenerative braking), to any one or more of the first, second and third torque transfer shafts 94, 98 and 102. Hence, via operation of the first, second and third clutch mechanisms 122, 126 and 130, the gearbox 78 is configureable to flexibly distribute, via the first, second and third torque transfer shafts 94, 98 and 102, the flow of power/torque generated by the ICE 18 and/or the ERM 70 and/or the rear axle differential 30, to any one or more of the rear axle differential 30 and the ERM 70.

For example, in various basic implementations, the gearbox 78 can be configured such that the PPFDS 66 is operable to supplement/assist the ICEDS 74 in providing motive power output to at least a portion of the drive train 10/40 of the vehicle 14′ and, when desired, to replace the ICEDS 74 in providing motive power output to at least a portion of the drive train 10/40. Hence, the vehicle 14′ can be driven utilizing motive power provided entirely by the ICEDS 74 (i.e., by the ICE 18), entirely by the PPFDS 66 (i.e., by the ERM 70), or driven utilizing motive power provided in part by the ICEDS 74 and in part by the PPFDS 66 (i.e., by the ICE 18 and the ERM 70). The ratio of motive power provided by the ICEDS 74 and the PPFDS 66 can be any desired ratio, based on the operation status/configuration of the gearbox 78, as described further below. In such implementations, the gearbox controller 82 will cause one or both of the first and third clutch mechanisms 122 and 130 to engage to direct torque generated from one or both of the ICE 18 and the ERM 70 into the gearbox 78, via the first and/or third torque transfer shaft 86 and/or 102, and will cause the second clutch mechanism 126 to engage to direct the torque delivered to the gearbox 78 from the gearbox 78 to the second torque transfer shaft 90.

Additionally, in various embodiments, the gearbox controller 82 can configure the gears within the gearbox 78 to deliver a desired amount of torque, between 0% and 100%, received from the first torque transfer shaft 86 (i.e., from the ICE 18) to the second power port (i.e., to the second torque transfer shaft 90 and hence to the rear axle differential 30) and/or to the fourth power port 134 (i.e., to the fourth torque transfer shaft 118 and hence to the auxiliary device 114)(described below with regard to FIG. 3B), and to deliver a desired amount of torque, between 0% and 100%, received from the third torque transfer shaft 102 (i.e., from the ERM 70) to the second power port (i.e., to the second torque transfer shaft 90 and hence to the rear axle differential 30) and/or to the fourth power port 134 (i.e., to the fourth torque transfer shaft 118 and hence to the auxiliary device 114).

Accordingly, the gearbox controller 82 can configure, or control the operation of, the gearbox 78 (i.e., the first, second and third clutch mechanisms 122, 126 and 130 and/or the gearbox gears) to control the power/torque delivered by the ICE 18 and the ERM 70 to the rear axle differential 30 and/or the auxiliary device 114. More specifically, the gearbox controller 82 can configure, or control the operation of, the gearbox 78 to selectively control the flow of power distribution to and from each of the first, second and third power ports 94, 98 and 106, thereby controlling the flow of power distribution to and from each first, second and third torque transfer shafts 86, 90 and 102, thereby controlling the flow of power distribution to and from each of the ICE 18, the ERM 70, the rear axle 30 and the auxiliary device 114.

Hence, in various configurations, the gearbox controller 82 can operate/configure the gearbox 78 to provide power flow distribution wherein torque generated by the ICE 18 is delivered in any ratio to the rear differential 30 and the ERM 70. And, in other configurations, the gearbox 78 can be configured/operated, via the gearbox controller 82, to provide power flow distribution wherein torque generated by the ERM 70 is delivered to the rear differential 30. And, in yet other configurations, the gearbox 78 can be configured/operated to provide power flow distribution wherein torque generated by the rear axle differential 30 is delivered to the ERM 30.

It should be noted that in the various 4-wheel drive embodiments described herein, the PPFDS 66 will additionally include a fifth clutch mechanism 142 (shown in FIGS. 4A and 4B) operatively disposed between the transmission 26 and the transfer case 46 that is controllable such that the transmission 26 can be effectively disengaged from the transfer case 46. Therefore, in when the PPFDS 66 is configured in a full electric mode, i.e., electric only mode, wherein 100% of the motive power provided by the ERM 70 (as described below), power from the ERM 70 can be delivered to the front axle differential 54, via the first torque transfer shaft 86, the transfer case 46 and the secondary driveshaft 58.

Importantly, the gearbox 78 can be configured/operated to provide power flow distribution wherein torque generated by any one or more of the ICE 18, the ERM 70 and the rear axle 30 is ‘feasibly delivered’ to any one or more of the ERM 70 and the rear axle 30. That is, as one skilled in the art would readily understand the gearbox 78 cannot be configured to simultaneously receive and deliver torque from and to any one of the ICE 18, the ERM 70 and the rear axle 30. For example, if gearbox 78 is configured to receive torque from the ERM 70, via the third torque transfer shaft 102, the gearbox 78 cannot feasibly (i.e., it is not mechanically possible to) simultaneously deliver torque generated by the ICE 18 to the ERM 70. However, the gearbox can be reconfigured to cease receiving torque from the ERM 70, at which point it would be feasible (i.e., mechanically possible) to deliver torque from the ICE 18 to the ERM 70.

For example, in various embodiments wherein the vehicle 14 is retrofitted with the PPFDS 66 to convert the vehicle 14 to the hybrid vehicle 14′, the gearbox 78 can be configured/operated to provide power flow distribution wherein 100% ICE 18 generated motive power, i.e., torque, is delivered to the rear differential 30, or 100% ERM 70 generated motive power, i.e., torque, is delivered to the rear differential 30, or any desired ratio of ICE 18 generated and ERM 70 generated motive power, i.e., torque, is delivered to the rear differential 30.

Referring now to FIGS. 3B and 4B, in various embodiments, the vehicle 14′ can include an auxiliary device 114 such as an air compressor, a hydraulic pump, and electric generator (in addition to the ERM 30 when configured as a generator), power generation/energy transformation devices, etc. for access and use by the vehicle operator. In such embodiments the PPFDS 66 further includes a forth torque transfer shaft 118 that is operatively connected at one end to a fourth power port 134 of the gearbox 78 and operatively connected at the opposing end to the auxiliary device 114. The fourth torque transfer shaft 118 is structured and operable to bidirectionally transfer torque between the gearbox 78 and the auxiliary device 114. Additionally, in such embodiments, the gearbox 78 further includes a fourth clutch mechanism 138 associated with the fourth power port 134 that is structured and operable to: 1) be engaged to direct torque from the fourth torque transfer shaft 118 into the gearbox 78; and 2) be engaged to direct torque from the gearbox 78 to the fourth torque shaft 118; and 3) be disengaged such that the fourth torque transfer shaft 118 is ‘neutralled’ and can neither direct torque into the gearbox 78 from the fourth torque transfer shaft 118, nor direct torque from the gearbox 78 to the fourth torque transfer shaft 118.

Further to the description above with regard to FIGS. 3A and 4A, in the various embodiments exemplarily illustrated in FIGS. 3B and 4B (and FIGS. 5-14 described further below) the gearbox 78 is configureable, via a vehicle operator operable gearbox controller 82, to selectively engage and/or disengage, individually or in any combination, each of the first, second, third and fourth clutch mechanisms 122, 126, 130 and 138 to receive and/or deliver torque to and/or from any one or more of the first, second, third and fourth torque transfer shafts 94, 98, 102 and 118. That is, gearbox 78 is configureable, via the operator controllable gearbox controller 82, to flexibly distribute the flow of power/torque generated by the ICE 18 and/or the ERM 70 and/or the rear axle differential 30 and/or the auxiliary device 114, to any one or more of the first, second, third and fourth torque transfer shafts 86, 90, 102 and 118. Hence, via operation of the first, second, third and fourth clutch mechanisms 122, 126, 130 and 138, the gearbox 78 is configureable to flexibly distribute, via the first, second, third and fourth torque transfer shafts 86, 90, 102 and 118, the flow of power/torque generated by the ICE 18 and/or the ERM 70, and/or the rear axle differential and/or the auxiliary device 114, to any one or more of the rear axle differential 30, the transfer case 46, the auxiliary device 114 and the ERM 70.

Still further to the description above with regard to FIGS. 3A and 4A, in the various embodiments exemplarily illustrated in FIGS. 3B and 4B (and FIGS. 5-14 described further below), the gearbox controller 82 can configure, or control the operation of, the gearbox 78 (i.e., the gearbox gears and the first, second, third and fourth clutch mechanisms 122, 126, 130 and 138) to control the power/torque delivered by the ICE 18 and/or the ERM 70 and/or the rear axle differential 30 and/or the auxiliary device 114 to the transfer case 46 and/or the ERM 70 and/or the rear axle differential 30 and/or the auxiliary device 114. More specifically, the gearbox controller 82 can configure, or control the operation of, the gearbox 78 to selectively control the flow of power distribution to and from each of the first, second, third and fourth power ports 94, 98, 106 and 134, thereby controlling the flow of power distribution to and from each first, second, third and fourth torque transfer shafts 86, 90, 102 and 118, thereby controlling the flow of power distribution to and from each ICE 18, the ERM 70, the rear axle 30 and the auxiliary device 114.

Hence, still yet further to the description above, in various implementations, the gearbox 78 can be configured/operated to provide power flow distribution wherein 0%-100% of torque generated by the ICE 18 is delivered to any one or more of the rear differential 30, the ERM 70 and the auxiliary device 114. And, in other implementations, the gearbox 78 can be configured/operated to provide power flow distribution wherein 0%-100% of torque generated by the ERM 70 is delivered to any one or more of the rear differential 30, the auxiliary device 114 and the transfer case 46. And, in still other implementations, the gearbox 78 can be configured/operated to provide power flow distribution wherein 0%-100% of torque generated by the rear axle differential 30 is delivered in any ratio to any one or more of the ERM 30, the auxiliary device 114 and the transfer case 46. In such instances the ERM 30 and/or the auxiliary device 114 (when the auxiliary device is a generator) can function to provide regenerative braking to the vehicle 14.

Importantly, the gearbox 78 can be configured/operated to provide power flow distribution wherein 0%-100% of torque generated by any one or more of the ICE 18, the ERM 70, the rear axle 30 and the auxiliary device 114 is ‘feasibly delivered’ to any one or more of the ERM 70, the rear axle 30, the transfer case 46 and the auxiliary device 114. That is, as one skilled in the art would readily understand the gearbox 78 cannot be configured to simultaneously receive and deliver torque from and to any one of the ICE 18, the ERM 70, the rear axle 30 and the auxiliary device 114. For example, if gearbox 78 is configured to receive torque from the ERM 70, via the third torque transfer shaft 102, and from the ICE 18, via the first torque shaft 86, the gearbox 78 cannot feasibly (i.e., it is not mechanically possible) simultaneously deliver torque generated by the rear axle 30 to the ERM 70. However, the gearbox can be reconfigured to cease receiving torque from the ERM 70, at which point it would be feasible (i.e., mechanically possible) to deliver torque from the rear axle differential 30 and/or the ICE 18 and/or the auxiliary device 114 to the ERM 70 (e.g., for regenerative braking and charging of the battery pack 110 by the ERM 70).

Referring to FIGS. 3A through 4B, in various embodiments, the gearbox 78 can further include a plurality of synchronizers that are structured and operable to allow the vehicle operator the change the configuration of the gearbox 78 to change the power flow distribution ‘On-The-Fly’, i.e., without stopping movement of the vehicle 14′.

Referring now to FIGS. 3A through 14, various exemplary configurations of the gearbox 78 and the resulting power flow distribution will now be described. As exemplarily illustrated in FIG. 5, in various embodiments, the gearbox 78 can be configured, via commands from the gearbox controller 82, such that the power flow is from the ICE 18 to the rear axle 30. That is, gearbox 78 can be configured such that the first clutch mechanism 122 is engaged to receive power/torque from the ICE 18, the second clutch mechanism 126 is engaged to deliver power/torque to the rear axle differential 30, and the third and fourth clutch mechanisms 130 and 134 are disengaged. Therefore, power/torque generated by the ICE 18 is received by the gearbox 78, via the first torque transfer shaft 86, and delivered by the gearbox 78 to the rear axle differential 30, via the second torque transfer shaft 90. The disengaged third and fourth clutch mechanisms 130 and 134 are illustrated in FIG. 5 by the letter ‘N’ on the respective third and fourth torque transfer shafts 102 and 118, representing that the third and fourth torque transfer shafts 102 and 118 are neutralled, i.e., the third and fourth torque transfer shafts 102 and 118 are in neutral whereby they are neither delivering power/torque to, nor receiving power/torque from, the gearbox 78.

Moreover, the letter ‘N’ is shown in FIGS. 5-14 to represent that the respective torque transfer shafts 86, 90, 102 and/or 118 are neutralled, i.e., the respective clutch mechanism 122, 126, 130 and/or 134 is disengaged, in the respective exemplary embodiment.

As exemplarily illustrated in FIG. 6, in various embodiments, the gearbox 78 can be configured, via commands from the gearbox controller 82, such that the power flow is from the ICE 18 to the ERM 70 wherein the ERM 70 functions as a generator. In such embodiments, no motive power is provided to either the rear axle differential 30 or the transfer case 46 of the vehicle 14′, hence, the vehicle 14′ is stationary. More particularly, in such embodiments, the gearbox 78 can be configured such that the first clutch mechanism 122 is engaged to receive power/torque from the ICE 18, the third clutch mechanism 130 is engaged to deliver power/torque to the ERM 70, and the second and fourth clutch mechanisms 126 and 134 are disengaged. Therefore, power/torque generated by the ICE 18 is received by the gearbox 78, via the first torque transfer shaft 86, and delivered by the gearbox 78 to the ERM 70, via the third torque transfer shaft 102.

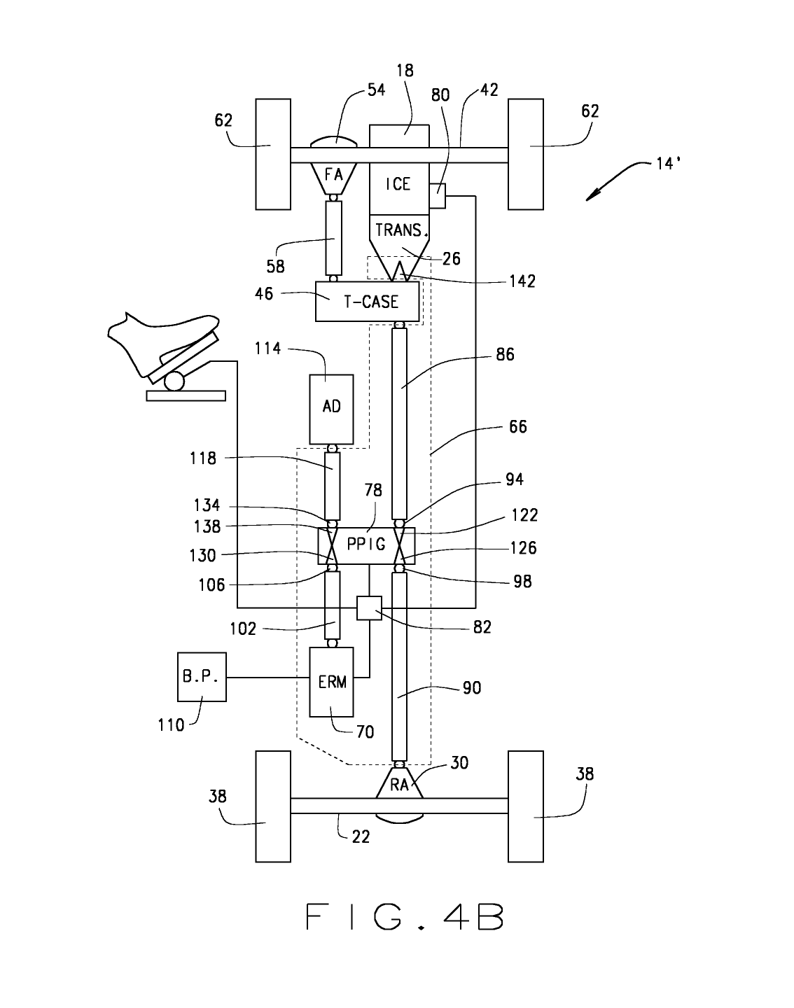

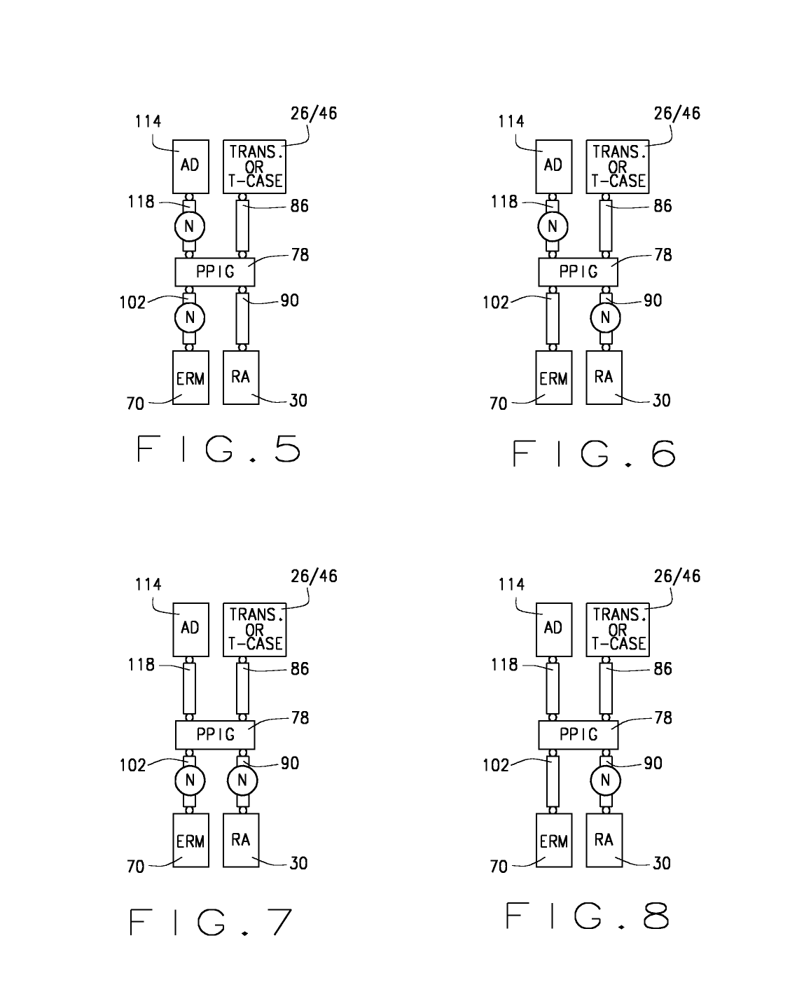

As exemplarily illustrated in FIG. 7, in various embodiments, the gearbox 78 can be configured, via commands from the gearbox controller 82, such that the power flow is from the ICE 18 to the auxiliary device 114. In such embodiments, no motive power is provided to the rear axle differential 30 of the vehicle 14′, hence, the vehicle 14′ is stationary. More particularly, in such embodiments, the gearbox 78 can be configured such that the first clutch mechanism 122 is engaged to receive power/torque from the ICE 18, the fourth clutch mechanism 134 are engaged to deliver power/torque to the auxiliary device 114, and the second and third clutch mechanisms 126 and 130 are disengaged. Therefore, power/torque generated by the ICE 18 is received by the gearbox 78, via the first torque transfer shaft 86, and delivered by the gearbox 78 to the auxiliary device 114, via the fourth torque transfer shaft 118.

As exemplarily illustrated in FIG. 8, in various embodiments, the gearbox 78 can be configured, via commands from the gearbox controller 82, such that the power flow is from the ICE 18 to the ERM 70 (wherein the ERM 70 functions as a generator) and to the auxiliary device 114. In such embodiments, no motive power is provided to the rear axle differential 30 of the vehicle 14′, hence, the vehicle 14′ is stationary. More particularly, in such embodiments, the gearbox 78 can be configured such that the first clutch mechanism 122 is engaged to receive power/torque from the ICE 18, the third and fourth clutch mechanisms 130 and 134 are engaged to deliver power/torque to the ERM 70 and the auxiliary device 114, and the second clutch mechanism 126 is disengaged. Therefore, power/torque generated by the ICE 18 is received by the gearbox 78, via the first torque transfer shaft 86, and delivered by the gearbox 78 to the ERM 70 and to the auxiliary device 114, via the third and fourth torque transfer shafts 102 and 118.

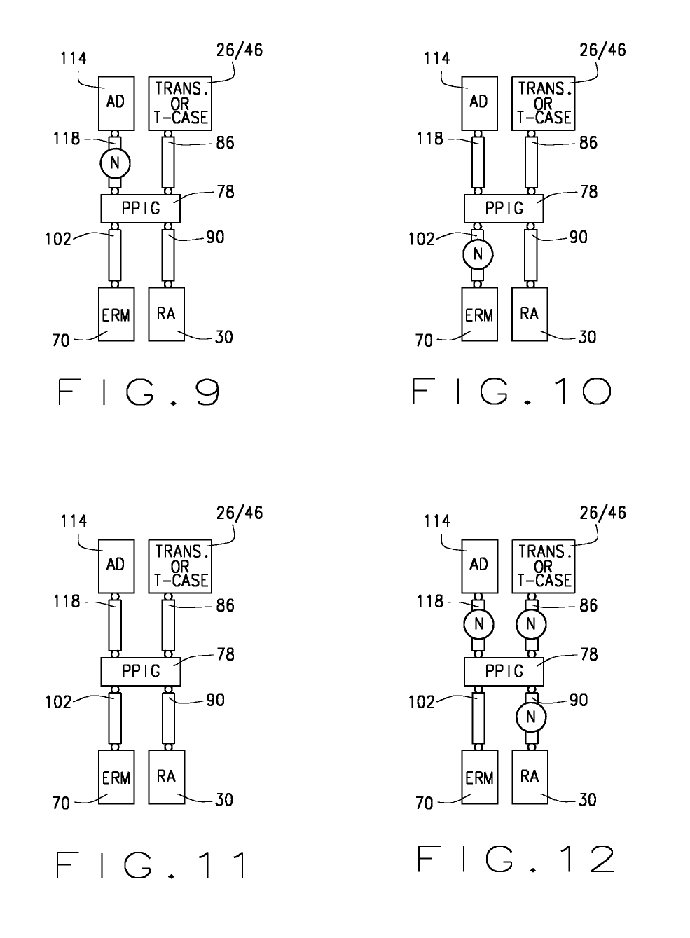

As exemplarily illustrated in FIG. 9, in various embodiments, the gearbox 78 can be configured, via commands from the gearbox controller 82, such that the power flow is from the ICE 18 to the ERM 70 (wherein the ERM 70 functions as a generator) and to the rear axle differential 30. More particularly, in such embodiments, the gearbox 78 can be configured such that the first clutch mechanism 122 is engaged to receive power/torque from the ICE 18, the second and third clutch mechanisms 126 and 130 are engaged to deliver power/torque to the ERM 70 and the rear axle differential 30, and the fourth clutch mechanism 134 is disengaged. Therefore, power/torque generated by the ICE 18 is received by the gearbox 78, via the first torque transfer shaft 86, and delivered by the gearbox 78 to the ERM 70 and to the rear axle differential 30, via the second and third torque transfer shafts 90 and 102.

As also exemplarily illustrated by FIG. 9, in various embodiments, the gearbox 78 can be configured, via commands from the gearbox controller 82, such that the power flow is from the ICE 18 and the ERM 70 (wherein the ERM 70 functions as an electric motor) to the rear axle differential 30. In such embodiments, motive power is provided to the rear axle differential 30 of the vehicle 14′ by both the ICE 30 and ERM 70, hence, the vehicle 14′ is driven in a hybrid mode, wherein motive power provided by the ICE 18 is supplemented by motive power provided by the ERM 70. More particularly, in such embodiments, the gearbox 78 can be configured such that the first and third clutch mechanisms 122 and 130 are engaged to receive power/torque from the ICE 18 and the ERM 70, the second clutch mechanism 126 is engaged to deliver power/torque to the rear axle differential 30, and the fourth clutch mechanism 134 is disengaged. Therefore, power/torque generated by the ICE 18 and the ERM 70 is received by the gearbox 78, via the first and third torque transfer shafts 86 and 102, and delivered by the gearbox 78 to the rear axle differential 30, via the second torque transfer shaft 90.

As exemplarily illustrated in FIG. 10, in various embodiments, the gearbox 78 can be configured, via commands from the gearbox controller 82, such that the power flow is from the ICE 18 to the auxiliary device 114 and to the rear axle differential 30. More particularly, in such embodiments, the gearbox 78 can be configured such that the first clutch mechanism 122 is engaged to receive power/torque from the ICE 18, the fourth and third clutch mechanisms 134 and 130 are engaged to deliver power/torque to the auxiliary device 114 and the rear axle differential 30, and the fourth clutch mechanism 134 is disengaged. Therefore, power/torque generated by the ICE 18 is received by the gearbox 78, via the first torque transfer shaft 86, and delivered by the gearbox 78 to the auxiliary device 114 and to the rear axle differential 30, via the fourth and third torque transfer shafts 118 and 102.

As exemplarily illustrated in FIG. 11, in various embodiments, the gearbox 78 can be configured, via commands from the gearbox controller 82, such that the power flow is from the ICE 18 to the ERM 70 (wherein the ERM 70 functions as a generator), the rear axle differential 30 and to the auxiliary device 114. More particularly, in such embodiments, the gearbox 78 can be configured such that the first clutch mechanism 122 is engaged to receive power/torque from the ICE 18, and the second, third and fourth clutch mechanisms 126, 130 and 134 are engaged to deliver power/torque to the ERM 70, the rear axle differential 30 and the auxiliary device 114. Therefore, power/torque generated by the ICE 18 is received by the gearbox 78, via the first torque transfer shaft 86, and delivered by the gearbox 78 to the ERM 70, the rear axle differential 30 and the auxiliary device 114, via the second, third and fourth torque transfer shafts 90, 102 and 118.

As also exemplarily illustrated by FIG. 11, in various embodiments, the gearbox 78 can be configured, via commands from the gearbox controller 82, such that the power flow is from the ICE 18 and the ERM 70 (wherein the ERM 70 functions as an electric motor) to the rear axle differential 30 and the auxiliary device 114. In such embodiments, motive power is provided to the rear axle differential 30 of the vehicle 14′ by both the ICE 30 and ERM 70, hence, the vehicle 14′ is driven in a hybrid mode, wherein motive power provided by the ICE 18 is supplemented by motive power provided by the ERM 70. More particularly, in such embodiments, the gearbox 78 can be configured such that the first and third clutch mechanisms 122 and 130 are engaged to receive power/torque from the ICE 18 and the ERM 70, and the second and fourth clutch mechanisms 126 and 134 are engaged to deliver power/torque to the rear axle differential 30 and the auxiliary device 114. Therefore, power/torque generated by the ICE 18 and the ERM 70 is received by the gearbox 78, via the first and third torque transfer shafts 86 and 102, and delivered by the gearbox 78 to the rear axle differential 30 and the auxiliary device 114, via the second and fourth torque transfer shafts 90 and 118.

As exemplarily illustrated in FIG. 12, in various embodiments, the gearbox 78 can be configured, via commands from the gearbox controller 82, such that the power flow is from the ERM 70 to the rear axle 30 (wherein the ERM 70 functions as an electric motor). Additionally, in such embodiments, the fifth, or transfer case, clutch mechanism 142 (shown in FIGS. 4A and 4B) would be controlled such that the transmission 26 is effectively disengaged from the transfer case 46. Hence, in such embodiments, the vehicle 14′ is driven a full electric mode, i.e., electric only mode, wherein 100% of the motive power provided by the ERM 70. In such embodiments, the gearbox 78 can be configured such that the third clutch mechanism 130 is engaged to receive power/torque from the ERM 70, the second clutch mechanism 126 is engaged to deliver power/torque to the rear axle differential 30, and the first, fourth and fifth clutch mechanisms 122, 134 and 142 are disengaged. Therefore, power/torque generated by ERM 70 is received by the gearbox 78, via the third torque transfer shaft 102, and delivered by the gearbox 78 to the rear axle differential 30, via the second torque transfer shaft 90 and/or front axle differential 54, via the first torque transfer shaft 86.

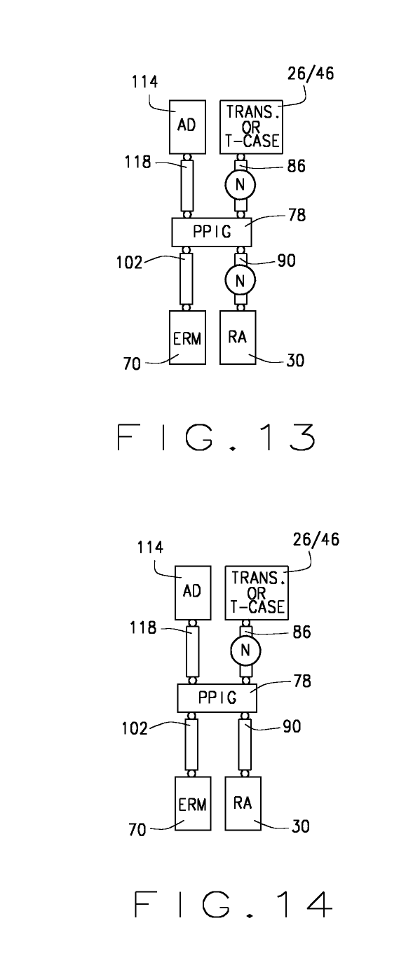

As exemplarily illustrated in FIG. 13, in various embodiments, the gearbox 78 can be configured, via commands from the gearbox controller 82, such that the power flow is from the ERM 70 to the auxiliary device 114 (wherein the ERM 70 functions as an electric motor). In such embodiments, no motive power is provided to either the rear axle differential 30 or the transfer case 46 of the vehicle 14′, hence, the vehicle 14′ is stationary. More particularly, in such embodiments, the gearbox 78 can be configured such that the third clutch mechanism 130 is engaged to receive power/torque from the ERM 70, the fourth clutch mechanism 134 is engaged to deliver power/torque to the auxiliary device 114, and the first and second clutch mechanisms 122 and 126 are disengaged. Therefore, power/torque generated by ERM 70 is received by the gearbox 78, via the third torque transfer shaft 130, and delivered by the gearbox 78 to the auxiliary device 114, via the fourth torque transfer shaft 118.

As exemplarily illustrated in FIG. 14, in various embodiments, the gearbox 78 can be configured, via commands from the gearbox controller 82, such that the power flow is from the ERM 70 to the rear axle 30 and to the auxiliary device 114 (wherein the ERM 70 functions as an electric motor). Additionally, in such embodiments, the fifth clutch mechanism 142 (shown in FIGS. 4A and 4B) would be controlled such that the transmission 26 is effectively disengaged from the transfer case 46, and thus from the rest of the drivetrain. Hence, in such embodiments, the vehicle 14′ is driven a full electric mode, wherein 100% of the motive power provided by the ERM 70. In such embodiments, the gearbox 78 can be configured such that the third clutch mechanism 130 is engaged to receive power/torque from the ERM 70, the second and fourth clutch mechanisms 126 and 134 are engaged to deliver power/torque to the rear axle differential 30 and the auxiliary device 114, and the first clutch mechanism 122 is disengaged. Therefore, power/torque generated by ERM 70 is received by the gearbox 78, via the third torque transfer shaft 130, and delivered by the gearbox 78 to the rear axle differential 30, and/or front axle differential 54, via the first torque transfer shaft 86, and to the auxiliary device 114, via the second and fourth torque transfer shafts 90 and 118.

As described herein, the gearbox controller 82 can control the gearbox 78 such that the gearbox 78 is configured, i.e., the gears within the gearbox 78 can be configured/arranged/operated, such that any desired percentage, i.e., 1% to 100%, of the power/torque received from any one or more of the ICE 18, the ERM 70, the rear axle differential 30 and the auxiliary device 114, can be feasibly delivered at any desired ratio to any one or more of the ERM 70, the rear axle differential 30, and the auxiliary device 114. For example, with reference to FIG. 8, the gearbox 78 can be configured to deliver 90% of the power/torque generated by the ICE 18 to the ERM 70 and auxiliary device 114, wherein 60% of the delivered power/torque is distributed to the ERM 70 and 40% of the delivered power/torque is distributed to the auxiliary device 114. Or, for example, with reference to FIG. 9, the gearbox 78 can be configured, i.e., the gears within the gearbox 78 can be configured/arranged/operated, such that any desired percentage, i.e., 1% to 100%, of the power/torque received from the ICE 18 can be delivered at any desired ratio to the ERM 70 and the rear axle differential 30. For example, the gearbox 78 can be configured to deliver 100% of the power/torque generated by the ICE 18 to the ERM 70 and rear axle differential 30, wherein 20% of the delivered power/torque is distributed to the ERM 70 and 80% of the delivered power/torque is distributed to the rear axle differential 30. Or, for example, with reference to FIG. 10, the gearbox 78 can be configured, i.e., the gears within the gearbox 78 can be configured/arranged/operated, such that any desired percentage, i.e., 1% to 100%, of the power/torque received from the ICE 18 can be delivered at any desired ratio to the auxiliary device 114 and the rear axle differential 30. For example, the gearbox 78 can be configured to deliver 95% of the power/torque generated by the ICE 18 to the auxiliary device 114 and rear axle differential 30, wherein 10% of the delivered power/torque is distributed to the auxiliary device 114 and 90% of the delivered power/torque is distributed to the rear axle differential 30.

Although various exemplary embodiments of implementation of the PPFDS 66 into the vehicle 14 to convert the vehicle 14 to the hybrid vehicle 14′ have been described and shown in FIGS. 5-14, there are various other embodiments of implementation that are possible and the present figures and description above should not be viewed as limiting the scope of the present disclosure.

Also, although the PPFDS 66 has been shown throughout the various figures and described above as including the first torque transfer shaft 86, it is envisioned that in various embodiments, the gearbox 78 can be directly mounted to the transmission 26 (2-wheel drive embodiments) or the transfer case 46 (4-wheel drive embodiments) such that PPFDS 66 does not include the first torque transfer shaft 86. Similarly, although the PPFDS 66 has been shown throughout the various figures and described above as including the third torque transfer shaft 102, it is envisioned that in various embodiments the gearbox 78 can be directly mounted to the ERM 70 such that PPFDS 66 does not include the third torque transfer shaft 102. Furthermore, although the PPFDS 66 has been shown and described above in various embodiments as including the fourth torque transfer shaft 118, it is envisioned that in various embodiments the gearbox 78 can be directly mounted to the auxiliary device 114 such that PPFDS 66 does not include the fourth torque transfer shaft 118.

Furthermore, as described above, it is envisioned that any vehicle 14 can be retrofitted with the PPFDS 66 to convert the vehicle 14 to the hybrid vehicle 14′. As will be readily, clearly, intuitively and without undue effort or experimentation be understood by one skilled in the art, e.g., a trained auto mechanic, retrofitting a fully assembled vehicle means that certain parts/components of the vehicle 14 will be disconnected and removed, or modified, and connected to or replaced with the various components of the PPFDS 66, described herein. For example, a skilled auto mechanic (i.e., one skilled in the art), without undue effort or experimentation, would intuitively, readily and easily understand that to retrofit the vehicle 14 with the PPFDS 66, the drive shaft 34 or 50 must be disconnected from the transmission 26 and rear axial differential 30 and removed, whereafter the PPFDS 66 would be installed in place of the removed drive shaft 34 or 50. Additionally, a skilled auto mechanic (i.e., one skilled in the art), without undue effort or experimentation, would intuitively, readily and easily understand that to retrofit the vehicle 14 with the PPFDS 66 that the various components of the PPFDS 66 that are not directly connected to the transmission 26 and rear axial differential 30 will be mounted (directly or indirectly) to suitable other existing structures of the vehicle 14 (e.g., the chassis frame of the vehicle 14).

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A retrofittable hybrid parallel power flow distribution system for a vehicle, said system comprising:
an electric rotating machine structured and operable to function as at least one of an electric motor and an electric generator;
a parallel power input gearbox structured and operable to receive torque from at least one of the electric rotating machine and an internal combustion engine of the vehicle and distribute the received torque to one or more of:
the electric rotating machine;
a rear axle differential of the vehicle; and
a transfer case of the vehicle;
a first torque transfer shaft operatively connected to a first power port of the gearbox and to the one of a transmission and the transfer case of the vehicle, the first torque transfer shaft structured and operable to bidirectionally transfer torque between the gearbox and the one of the transmission and the transfer case of the vehicle;
a second torque transfer shaft operatively connected to a second power port of the gearbox and to the rear axle differential of the vehicle, the second torque transfer shaft structured and operable to bidirectionally transfer torque between the gearbox and the rear axle differential;
a third torque transfer shaft operatively connected to a third power port of the gearbox and to the electric rotating machine, the third torque transfer shaft structured and operable to bidirectionally transfer torque between the gearbox and the electric rotating machine; and
a parallel power input gearbox controller structured and operable to control the configuration, operation and functionality of the parallel power input gear box, wherein the parallel power input gearbox comprises:
a plurality of gears that are operatively engageable with each other and with the first, second and third torque transfer shafts, via the respective power ports, to selectively distribute the flow of the torque generated by the at least one of the electric rotating machine and an internal combustion engine any one or more of the first, second, and third torque transfer shafts; and
a plurality of synchronizers that are structured and operable to allow configuration of the parallel power input gearbox without stopping movement of the vehicle.

2. The system of claim 1, wherein the parallel power input gearbox is further structured and operable to distribute the received torque to one or more of:
the electric rotating machine;
the rear axle differential of the vehicle;
the transfer case of the vehicle; and
an auxiliary device of the vehicle,
and wherein the system further comprising a fourth torque transfer shaft operatively connected to a fourth power port of the gearbox and to the auxiliary device of the vehicle, the fourth torque transfer shaft structured and operable to bidirectionally transfer torque between the gearbox and the auxiliary device.

3. The system of claim 2, wherein the parallel power input gearbox comprises a plurality of clutch mechanisms, each clutch mechanism associated with a respective one of the power ports and structured and operable to:
be engaged to direct torque from the respective torque transfer shaft into the gearbox;
be engaged to direct torque from the gearbox to the respective torque transfer shaft; and
be disengaged such that the respective torque transfer shaft cannot direct torque into the gearbox from the respective torque transfer shaft, and cannot direct torque from the gearbox to the respective torque transfer shaft,
wherein the gearbox is configureable, via control of the parallel power input gearbox controller, to one of selectively engage and selectively disengage each respective clutch mechanism.

4. A method for flexibly distributing the flow of power generated by at least one of an internal combustion engine and an electric rotating machine of a hybrid vehicle, said method comprising:
removing a driveshaft from a vehicle;
replacing the driveshaft with a retrofittable hybrid parallel power flow distribution system;
receiving torque from at least one of an electric rotating machine of the parallel power flow distribution system and an internal combustion engine of the vehicle at a parallel power input gearbox of the parallel power flow distribution system; and
controlling, via parallel power input gearbox controller, operation of the gearbox to at least one of:
bidirectionally transferring, without stopping the vehicle, the received torque between the gearbox and one of a transmission and a transfer case of the vehicle utilizing a first torque transfer shaft of the parallel power flow distribution system operatively connected to a first power port of the gearbox and to the one of the transmission and the transfer case of the vehicle;
bidirectionally transferring, without stopping the vehicle, the received torque between the gearbox and a rear axle differential of the vehicle utilizing a second torque transfer shaft of the parallel power flow distribution system operatively connected to a second power port of the gearbox and to the rear axle differential; and
bidirectionally transferring, without stopping the vehicle, the received torque between the gearbox and the electric rotating machine utilizing a third torque transfer shaft of the parallel power flow distribution system operatively connected to a third power port of the gearbox and to the electric rotating machine.

5. The method of claim 4, wherein controlling, via parallel power input gearbox controller, operation of the gearbox comprises at least one of:
bidirectionally transferring, without stopping the vehicle, the received torque between the gearbox and one of the transmission and the transfer case of the vehicle utilizing the first torque transfer shaft of the parallel power flow distribution system operatively connected to the first power port of the gearbox and to the one of the transmission and the transfer case of the vehicle;
bidirectionally transferring, without stopping the vehicle, the received torque between the gearbox and the rear axle differential of the vehicle utilizing the second torque transfer shaft of the parallel power flow distribution system operatively connected to the second power port of the gearbox and to the rear axle differential; and
bidirectionally transferring, without stopping the vehicle, the received torque between the gearbox and the electric rotating machine utilizing the third torque transfer shaft of the parallel power flow distribution system operatively connected to the third power port of the gearbox and to the electric rotating machine;
bidirectionally transferring, without stopping the vehicle, torque between the gearbox and an auxiliary device of the vehicle utilizing a fourth torque transfer shaft of the parallel power flow distribution system operatively connected to a fourth power port of the gearbox and to the auxiliary device.

6. The method of claim 5, wherein the parallel power input gearbox comprises a plurality of clutch mechanisms, each clutch mechanism associated with a respective one of the power ports, and wherein controlling, via parallel power input gearbox controller, operation of the gearbox further comprises controlling the clutch mechanisms to one of:
engage any one or more of the clutch mechanisms, without stopping the vehicle, to direct torque from the respective torque transfer shaft into the gearbox;
engage any one or more of the clutch mechanisms, without stopping the vehicle, to direct torque from the gearbox to the respective torque transfer shaft;
disengage any one or more of the clutch mechanisms, without stopping the vehicle, such that the respective the respective torque transfer shaft cannot direct torque into the gearbox from the respective torque transfer shaft, and cannot direct torque from the gearbox to the respective torque transfer shaft.

7. A vehicle comprising:
a retrofittable hybrid parallel power flow distribution system, said system comprising:
an electric rotating machine structured and operable to function as at least one of an electric motor and an electric generator;
a parallel power input gearbox structured and operable to receive torque from at least one of the electric rotating machine and an internal combustion engine of the vehicle and distribute the received torque to one or more of:
the electric rotating machine;
a rear axle differential of the vehicle; and
a transfer case of the vehicle;
a first torque transfer shaft operatively connected to a first power port of the gearbox and to the one of a transmission and the transfer case of the vehicle, the first torque transfer shaft structured and operable to bidirectionally transfer torque between the gearbox and the one of the transmission and the transfer case of the vehicle;
a second torque transfer shaft operatively connected to a second power port of the gearbox and to the rear axle differential of the vehicle, the second torque transfer shaft structured and operable to bidirectionally transfer torque between the gearbox and the rear axle differential; and
a third torque transfer shaft operatively connected to a third power port of the gearbox and to the electric rotating machine, the third torque transfer shaft structured and operable to bidirectionally transfer torque between the gearbox and the electric rotating machine, wherein the parallel power input gearbox comprises:
a plurality of gears that are operatively engageable with each other and with the first, second and third torque transfer shafts, via the respective power ports, to selectively distribute the flow of the torque generated by the at least one of the electric rotating machine and an internal combustion engine any one or more of the first, second, and third torque transfer shafts; and
a plurality of synchronizers that are structured and operable to allow configuration of the parallel power input gearbox without stopping movement of the vehicle.

8. The vehicle of claim 7, wherein the parallel power input gearbox is further structured and operable to distribute the received torque to one or more of:
the electric rotating machine;
the rear axle differential of the vehicle;
the transfer case of the vehicle; and
an auxiliary device of the vehicle,
and wherein the system further comprising a fourth torque transfer shaft operatively connected to a fourth power port of the gearbox and to the auxiliary device of the vehicle, the fourth torque transfer shaft structured and operable to bidirectionally transfer torque between the gearbox and the auxiliary device.

9. The vehicle of claim 8, wherein the parallel power input gearbox comprises a plurality of clutch mechanisms, each clutch mechanism associated with a respective one of the power ports and structured and operable to:
be engaged to direct torque from the respective torque transfer shaft into the gearbox;
be engaged to direct torque from the gearbox to the respective torque transfer shaft; and
be disengaged such that the respective torque transfer shaft cannot direct torque into the gearbox from the respective torque transfer shaft, and cannot direct torque from the gearbox to the respective torque transfer shaft,
wherein the gearbox is configureable, via control of the parallel power input gearbox controller, to one of selectively engage and selectively disengage each respective clutch mechanism.
